(19) United States
(12) Patent Application Publication
(10) Pub. No.: US 2014/0202357 A1
(43) Pub. Date: Jul. 24, 2014

(54) ASPHALT CUTBACK FORMULATIONS

(71) Applicant: Special Materials Company, New York, NY (US)

(72) Inventors: Jordan L. Blank, Lake Worth, FL (US); James E. Nevin, Lake Worth, FL (US)

(73) Assignee: Special Materials Company, New York, NY (US)

(21) Appl. No.: 14/158,203

(22) Filed: Jan. 17, 2014

Related U.S. Application Data
(60) Provisional application No. 61/754,518, filed on Jan. 18, 2013.

(51) Int. Cl. C09D 195/00

(52) U.S. Cl. CPC C09D 195/00
USPC 106/163.01; 106/278

(57) ABSTRACT

There is disclosed embodiments of a composition comprising asphalt and an organic solvent and an additive, wherein the composition has at least one of increased viscosity, increased adhesion to a surface, decreased curing time, and improved maintenance of gel structure as compared to a control composition lacking said additive.

### CROSS-REFERENCE TO RELATED APPLICATIONS

This application claims the benefit of U.S. Application 61/754,518 filed on Jan. 18, 2013, the contents of which are incorporated herein by reference.

### FIELD

The present disclosure provides hydrocarbon solvents used to prepare cutback systems with asphalt and other bituminous substances, asphalt cutback formulations, methods for their production, and the products prepared therefrom. In a specific embodiment, the present disclosure provides asphalt cutback compositions that comprise dimethylcarbonate, methods for the production of those compositions, methods of use of those compositions, and the products made therefrom.

### BACKGROUND

Asphalt's unique combination of physical and chemical properties along with its historical low cost and ready availability are the predominant contributing factors in its widespread use particularly in waterproofing, paving and roofing applications. Asphalt is the most common form of binding agent used in paving cements and sealers and is still used as the principal adhesive and waterproofing agent in pavement binders, roof shingles, rolled roofing goods, built-up roofing, below-grade waterproofing and trowelable cements. In totality, the use of asphalt based products in construction breaks down to 75% in road construction, 15% in roofing products and 10% in coatings, adhesives and batteries. (Asphalt Materials Handbook; training ce.washington.edu).

Asphalt has been used for centuries in a wide variety of applications. The first recorded use by humans came around the time period 3000 B.C. where the Sumerian people used it as an adhesive to attach various precious stones, pearls and shells to statues. In the time period 2000 BC asphalt has been determined to have been used in the construction of the walls and towers of Babylon and as a waterproofing agent for ship building, having been discovered in pits and springs nearby in Ardericca and on the island of Zacynthus; (Chisholm, Hugh, ed (1911) “Petroleum” Encyclopcedia Britannica (Eleventh Ed. Cambridge University Press).

Early use in North America dates back to the 13^{th} century when the Tongva, Luiseño and Chumash peoples used asphalt sourced from surface collections of subterranean petroleum deposits. Asphalt has been used as the principal component in paving binders since at least 1870 when a street in Newark, N.J. at the City Hall was paved with asphalt cement. Later in 1876, Pennsylvania Avenue in Washington D.C. was paved with asphalt cement in time for the celebration of the national centennial; McNichol, Dan (2005), Paving the Way: Asphalt in America. Lanham, Md.: National Asphalt Pavement Association. ISBN 0-914313-04-5.

In the time between the first paving projects in the United States and the present approximately 2.27 million miles of roadway have been paved and of that total, 94 percent is comprised of asphalt cement vs. all of the competing forms of road construction combined including concrete cement and natural pitch type binding agent cements. (asphalt.com/asphalt%2520facts.htm).

Raw asphalt is a manufactured composition produced from the fractional distillation of petroleum into fuels, solvents, petrochemical feed stocks and waxes. Asphalt primarily comprises two fractions often referred to as Maltenes and Asphaltenes. Maltenes are the continuous phase of asphalt and can be extracted using n-alkane solvents such as heptane and pentane meaning that they are principally non-polar hydrocarbons. Maltenes can be comprised of naphthenes, naphthene aromatics and olefins among other carbonaceous compounds.

Asphaltenes are considered the dispersed or discontinuous phase and are the component of asphalt that are not soluble in heptanes meaning that they have a certain polar constituency to their chemical structure and contain elements such as nitrogen, oxygen and sulfur in their chemical structures formed into hetero-aromatic compounds and polyfunctional molecules such as amines, amides, phenols and carboxylic acids. Asphaltenes also contain metal complexes of Nickel and Vanadium mostly formed in association with pyrrole nitrogen atoms in porphyrin ring structures (Asphalt Science and Technology, Arthur Usmani 1997).

There is a continuing need in the art for improved compositions and formulations that facilitate, improve and expand the applications for asphalt-containing materials.

### SUMMARY

Although the terms bitumen and asphalt may be considered to refer to materials that are not identical in their complex chemical composition, these terms are meant to be used interchangeably herein. Accordingly, the description below, which employs the term “asphalt” throughout is meant to encompass all corresponding compositions, solvents, products, methods and kits in which the solvent or additive is identified as “bitumen” rather than, as well as in addition to, “asphalt.”

In one embodiment, the present disclosure is directed to a composition comprising asphalt, an organic solvent and an additive, wherein said composition has at least one advantage of increased viscosity, increased adhesion to a surface, decreased curing time, and improved maintenance of gel structure as compared to a control composition lacking that additive

In one aspect of this embodiment, the additive is of formula R¹O—C(O)—OR², wherein R¹ and R² are each independently selected from C₁-C₈ alkyl, C₂-C₈ alkenyl, and C₃-C₈ alkynyl. In a further aspect, the additive is R¹O—C(O)—OR², wherein R¹ and R² are each independently selected from C₁-C₈ alkyl.

In another aspect, the additive is R¹O—C(O)—OR², wherein R¹ and R² are each independently selected from C₁-C₆ alkyl. In still further aspects, R¹ and R² are each independently selected from C₁-C₄ alkyl, or R¹ and R² are each independently selected from C₁-C₂ alkyl.

In one specific embodiment, the additive is R¹O—C(O)—OR² in which R¹ and R² are both methyl, i.e., the additive is dimethylcarbonate.

In other embodiments these compositions may further comprise at least one of a clay mineral and a surfactant.

In certain embodiments, the additive makes up from 1% to 50% by weight of the total composition.

In certain embodiments, the organic solvent of the composition comprises mineral spirits, gasoline, toluene, xylene, naphtha, fuel oil, or a combination of two or more thereof. In one aspect of this embodiment, the fuel oil comprises kerosene, diesel oil, or a combination thereof.

In certain other embodiments, the present disclosure provides an asphalt containing composition in which the solvent is or comprises an organic solvent of formula R¹O—C(O)—OR². Accordingly, the present disclosure further provides a composition comprising asphalt and an organic solvent of formula R¹O—C(O)—OR², wherein R¹ and R² are each independently selected from C₁-C₈ alkyl, C₂-C₈ alkenyl, and C₃-C₈ alkynyl. In certain embodiments, this composition comprises organic solvent of formula R¹O—C(O)—OR², wherein R¹ and R² are each independently selected from C₁-C₈ alkyl, while in other embodiments, R¹ and R² are each independently selected from C₁-C₆ alkyl. In still further embodiments, R¹ and R² are each independently selected from C₁-C₄ alkyl. In another embodiment, R¹ and R² are each independently selected from C₁-C₂ alkyl.

In a particular embodiment, the present disclosure further provides a composition comprising asphalt and an organic solvent of formula R¹O—C(O)—OR², wherein R¹ and R² are both methyl.

In further embodiments, the compositions disclosed herein, which comprise asphalt and an organic solvent of formula R¹O—C(O)—OR², further comprise at least one viscosity-increasing additive, which may, e.g., a clay mineral and a surfactant. Such composition may comprise from 1% to 50% organic solvent by weight of the total composition.

In other embodiments, the compositions disclosed herein, which comprise asphalt and an organic solvent of formula R¹O—C(O)—OR², further comprise a co-solvent. In one aspect of this embodiment, the co-solvent is mineral spirits, gasoline, toluene, xylene, naphtha, fuel oil, or a combination of two or more thereof. In further aspects of this embodiment, the fuel oil comprises kerosene, diesel oil, or a combination thereof. In another aspect, the co-solvent comprises a synthetic solvent such as parachlorobenzotrifluoride or mixture of synthetic solvents. In a still further aspect, the co-solvent comprises a natural solvent or a mixture of natural solvents, e.g., d-limonene, a coniferous tree extract, or a mixture thereof. In one embodiment, the coniferous tree extract comprises turpentine.

In certain embodiments, compositions disclosed herein, which comprise asphalt and an organic solvent of formula R¹O—C(O)—OR², are those in which the organic solvent comprises from 1% to 99% by weight of the total of organic solvent and co solvent. In a particular embodiment, the organic solvent is dimethyl carbonate.

The present disclosure further provides a method of making an asphalt cutback composition, the method comprising combining asphalt and an organic solvent of formula R¹O—C(O)—OR², as described above, wherein R¹ and R² are each independently selected from C₁-C₈ alkyl, C₂-C₈ alkenyl, and C₃-C₈ alkynyl.

The present disclosure also provides a method of making an asphalt cutback composition, the method comprising combining asphalt, an organic solvent, and an additive, wherein the additive, as described above, is of formula R¹O—C(O)—OR², wherein R¹ and R² are each independently selected from C₁-C₈ alkyl, C₂-C₈ alkenyl, and C₃-C₈ alkynyl.

The present disclosure also provides products comprising the solvents, solvent mixtures, and/or the additives described above. Such products include for example, paving cements and sealers. Such product also include, but are not limited to, a pavement binder, roof shingle, rolled roofing good, built-up roofing material, below-grade waterproofing material, trowelable cement, dust suppressant agents, and controlled-release fertilizer coatings.

The present disclosure further provides a solvent for use in the production of asphalt cutback that is exempt from federal and state environmental laws governing the use of Volatile Organic Compounds in products such as, without limitation, asphalt-based cements, adhesives and coatings.

The present disclosure also provides a cost-effective alternative to expensive solvents for use in asphalt cutback systems, such as parachlorobenzotrifluoride.

The present disclosure provides a solvent for asphalt cutback systems that has a faster rate of evaporation than solvents currently used, thereby accelerating the cure rate.

As such, compositions of the disclosure are particularly useful in cold environments where delayed curing can create problems with the application.

The present disclosure provides additives, solvents, and solvent systems for producing asphalt cutback that enhance the activity of viscosity enhancing additives such as attapulgite clay with amine based surfactants thereby reducing the quantity of expensive co-additives necessary to achieve the desired level of viscosity.

The present disclosure also provides a kit comprising, in separate containers, asphalt and an organic solvent of formula R¹O—C(O)—OR², wherein R¹ and R² are each independently selected from C₁-C₈ alkyl, C₂-C₈ alkenyl, and C₃-C₈ alkynyl. In one aspect of this embodiment, R¹ and R² are both methyl. In another aspect, the kit may further comprise, in one or more separate containers, at least one viscosity increasing additive, selected from the group consisting of a clay mineral a surfactant, a cellulose fiber, and calcium carbonate.

In another embodiment, the present disclosure further provides a kit comprising, in two or more separate containers, asphalt, an organic solvent, and an additive of formula R¹O—C(O)—OR², wherein R¹ and R² are each independently selected from C₁-C₈ alkyl, C₂-C₈ alkenyl, and C₃-C₈ alkynyl. In one aspect of this embodiment, R¹ and R² are both methyl. In another aspect of this embodiment, the kit may further comprise, in one or more separate containers, at least one additional viscosity-increasing additive selected from the group consisting of a clay mineral a surfactant, a cellulose fiber, and calcium carbonate.

### BRIEF DESCRIPTION OF THE DRAWING

FIG. 1 depicts the petroleum refining process works whereby crude oil is systematically divided into gasses such as propane and butane, streams of chemicals such as sulfur, fuels such as gasoline, kerosene and diesel and of heavy ends such as waxes and asphalt.

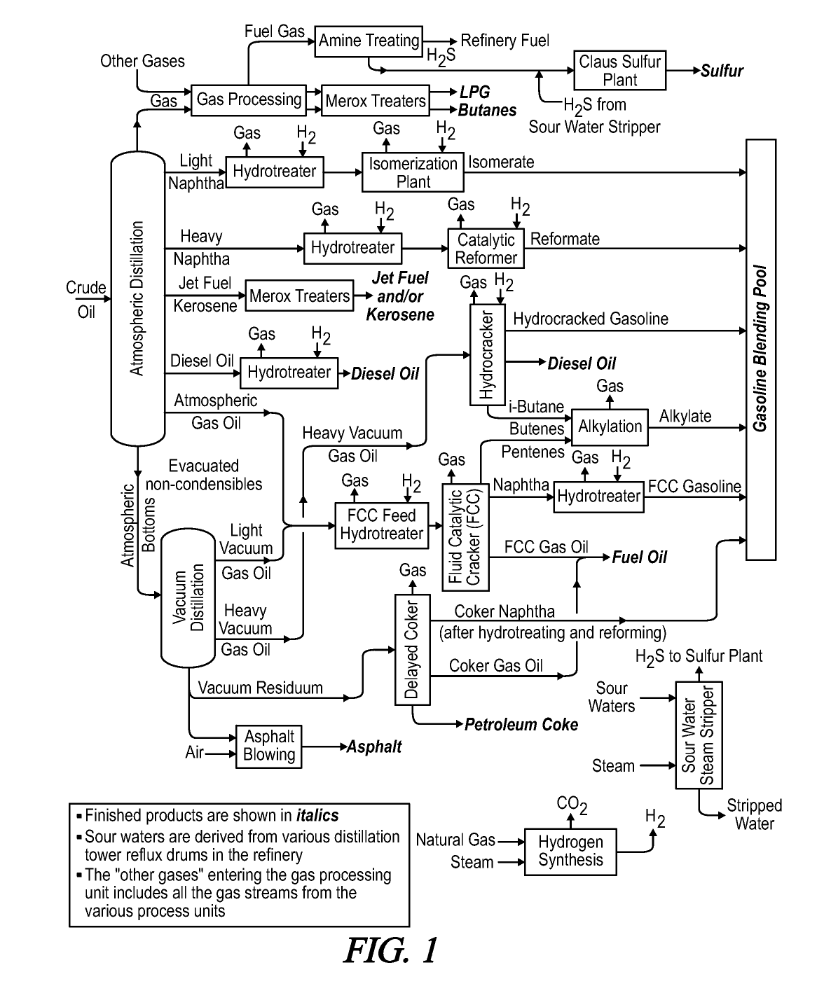

### DETAILED DESCRIPTION

Asphalt-based products in which asphalt is blended with a volatile hydrocarbon solvent are referred to as asphalt cutback systems by those skilled in the art. Such cutback systems have been used for more than a century as a means of packaging and applying cold-applied asphalt products; i.e., the products are stored and used cold and then they cure as the result of solvent evaporation. The viscosity of the cutback system is adjusted to provide a material having a workable viscosity.

In certain embodiments, asphalt compositions disclosed herein are first heated in a truck or a portable kettle to a temperature above which the composition is free-flowing and can be poured or pumped for spraying, brushing or mopping on the application substrate. These hot-mopped asphalts can be used in conjunction with asphalt-saturated felt to produce a layered surface known as a Built-up-Roof or BUR.

In other embodiments, the asphalt compositions disclosed herein are dispersed into an aqueous system and a colloidal clay or a cationic or anionic chemical emulsifier where the water is generally the continuous phase. The emulsion systems are designed to destabilize or “break” upon interaction with intended conditions such as incompatible electronic charge of small stones called aggregates (charge breaking) or from evaporation from exposure to the atmosphere (evaporative breaking). The mechanism of breaking causes the asphalt and water to separate wherein the water evaporates leaving behind the asphalt binder composition along with the other components in the system such as aggregates forming asphalt cement.

Asphalt composition disclosed herein (i.e., including compositions comprising the additives described herein), can be used as a binder comprising additional materials designed to impart technically advanced qualities that asphalt alone does not possess. Among the most important of these additives are: block co-polymers such as Styrene-Butadiene-Styrene (SBS), Styrene-Isoprene-Styrene (SIS) and Styrene-Ethylene-Butylene-Styrene (SEBS), which impart superior tensile and cohesive strength as well as elasticity. Other important additives include; sulfur which serves to cross-link or polymerize the styrenic block copolymers; fatty amines which impart superior adhesion or anti-striping qualities to aggregates; antioxidants which extend the useful life of the finished product by delaying the formation of cracks in the pavement and solvents which allow for the ambient environmental use of asphalt based cements, coatings and adhesives. (Asphalt Science and Technology; 1997 by Marcel Dekker).

Volatile Organic Compounds, heretofore referred to as VOC's, have been by the United States Environmental Protection Agency as “any organic compound that participates in a photoreaction.”

In particular embodiments, asphalt is diluted or “cut” with solvents as part of a complex composition or network, that may further include functional additives such as polymers and surfactants as well as inert additives such as filler clays and cellulose fibers. These additives are included in cutback formulations to provide compositions with specific functional properties such as viscosity, elasticity adhesion and cure rate

In one embodiment, the present disclosure is directed to a composition comprising asphalt, an organic solvent and an additive, wherein said composition has at least one of increased viscosity, increased adhesion to a surface, decreased curing time, and improved maintenance of gel structure as compared to a control composition lacking that additive.

In one aspect of this embodiment, the additive is of formula R¹O—C(O)—OR², wherein R¹ and R² are each independently selected from C₁-C₈ alkyl, C₂-C₈ alkenyl, and C₃-C₈ alkynyl. In a further aspect, the additive is R¹O—C(O)—OR², wherein R¹ and R² are each independently selected from C₁-C₈ alkyl.

In another aspect, the additive is R¹O—C(O)—OR², wherein R¹ and R² are each independently selected from C₁-C₆ alkyl. In still further aspects, R¹ and R² are each independently selected from C₁-C₄ alkyl, or R¹ and R² are each independently selected from C₁-C₂ alkyl.

In one specific embodiment, the additive is R¹O—C(O)—OR² in which R¹ and R² are both methyl, i.e., the additive is dimethylcarbonate.

In other embodiments these compositions may further comprise at least one of a clay mineral and a surfactant.

In certain embodiments, the additive makes up from 1% to 50% by weight of the total composition.

In certain embodiments, the organic solvent of the composition comprises mineral spirits, gasoline, toluene, xylene, naphtha, fuel oil, or a combination of two or more thereof. In one aspect of this embodiment, the fuel oil comprises kerosene, diesel oil, or a combination thereof.

The present disclosure further provides a composition comprising asphalt and an organic solvent of formula R¹O—C(O)—OR², wherein R¹ and R² are each independently selected from C₁-C₈ alkyl, C₂-C₈ alkenyl, and C₃-C₈ alkynyl.

In certain embodiments, this composition comprises an organic solvent of formula R¹O—C(O)—OR², wherein R¹ and R² are each independently selected from C₁-C₈ alkyl, while in other embodiments, R¹ and R² are each independently selected from C₁-C₆ alkyl. In still further embodiments, R¹ and R² are each independently selected from C₁-C₄ alkyl. In another embodiment, R¹ and R² are each independently selected from C₁-C₂ alkyl.

In a particular embodiment, the present disclosure further provides a composition comprising asphalt and an organic solvent of formula R¹O—C(O)—OR², wherein R¹ and R² are both methyl.

In further embodiments, the compositions disclosed herein, which comprise asphalt and an organic solvent of formula R¹O—C(O)—OR², further comprise at least one of a clay mineral and a surfactant. Such composition may comprise from 1% to 50% organic solvent by weight of the total composition.

In other embodiments, the compositions disclosed herein, which comprise asphalt and an organic solvent of formula R¹O—C(O)—OR², further comprise a co-solvent. In one aspect of this embodiment, the co-solvent is mineral spirits, gasoline, toluene, xylene, naphtha, fuel oil, or a combination of two or more thereof. In further aspects of this embodiment, the fuel oil comprises kerosene, diesel oil, or a combination thereof. In another aspect, the co-solvent comprises a synthetic solvent or mixture of synthetic solvents, e.g., parachlorobenzotrifluoride. In a still further aspect, the co-solvent comprises a natural solvent or a mixture of natural solvents, e.g., d-limonene, a coniferous tree extract, or a mixture thereof. In one embodiment, the coniferous tree extract comprises turpentine.

In certain embodiments, compositions disclosed herein, which comprise asphalt and an organic solvent of formula R¹O—C(O)—OR², are those in which the organic solvent comprises from 1% to 99% by weight of the total of organic solvent and co solvent. In a particular embodiment, the organic solvent is dimethyl carbonate.

The present disclosure further provides a method of making an asphalt cutback composition, the method comprising combining asphalt and an organic solvent of formula R¹O—C(O)—OR², as described above, wherein R¹ and R² are each independently selected from C₁-C₈ alkyl, C₂-C₈ alkenyl, and C₃-C₈ alkynyl.

The present disclosure also provides a method of making an asphalt cutback composition, the method comprising combining asphalt, an organic solvent, and an additive, wherein the additive, as described above, is of formula R¹O—C(O)—OR², wherein R¹ and R² are each independently selected from C₁-C₈ alkyl, C₂-C₈ alkenyl, and C₃-C₈ alkynyl.

The present disclosure also provides products comprising the solvents, solvent mixtures, and/or the additives described above. Such products include for example, paving cements and sealers. Such product also include, but are not limited to, a pavement binder, roof shingle, rolled roofing good, built-up roofing material, below-grade waterproofing material, or a trowelable cement. Such products also include but are not limited to, a dust control agent and a fertilizer coating.

The present disclosure further provides a solvent for use in the production of asphalt cutback that is exempt from federal and state environmental laws governing the use of Volatile Organic Compounds in products such as, without limitation, asphalt-based cements, adhesives and coatings.

The present disclosure also provides a cost-effective alternative to expensive solvents for use in asphalt cutback systems, such as parachlorobenzotrifluoride.

The present disclosure provides a solvent for asphalt cutback systems that has a faster rate of evaporation than solvents currently used, thereby accelerating the cure rate. As such, compositions of the disclosure are particularly useful in cold environments where delayed curing can create problems with the application.

The present disclosure provides additives, solvents, and solvent systems for producing asphalt cutback that enhance the activity of viscosity enhancing additives such as attapulgite clay with amine based surfactants thereby reducing the quantity of expensive co-additives necessary to achieve the desired level of viscosity.

In certain embodiments, dimethyl carbonate is used as a partial or total replacement solvent for other solvents used in the art, e.g., mineral spirits, for the manufacture of asphalt cutbacks. In one aspect of this embodiment, the asphalt cutback is produced uses dimethyl carbonate (DMC) as the sole solvent wherein the level of VOC in the formulation would be at or near zero depending upon the VOC content within the asphalt itself. In other embodiments, the asphalt cutback is produced using dimethyl carbonate as a co-solvent along with other such exempt solvents such as parachlorobenzotrifluoride as well as non-exempt solvents such as mineral spirits. The exact concentration of co-solvents is related to the desired level of VOC content as well as other physical and chemical properties, including, e.g., the rate of evaporation and viscosity.

The present disclosure also provides a kit comprising, in separate containers, asphalt and an organic solvent of formula R¹O—C(O)—OR², wherein R¹ and R² are each independently selected from C₁-C₈ alkyl, C₂-C₈ alkenyl, and C₃-C₈ alkynyl. In one aspect of this embodiment, R¹ and R² are both methyl. In another aspect, the kit may further comprise, in one or more separate containers, at least one viscosity increasing additive, selected from the group consisting of a clay mineral a surfactant, a cellulose fiber, and calcium carbonate. In another embodiment, the present disclosure further provides a kit comprising, in two or more separate containers, asphalt, an organic solvent, and an additive of formula R¹O—C(O)—OR², wherein R¹ and R² are each independently selected from C₁-C₈ alkyl, C₂-C₈ alkenyl, and C₃-C₈ alkynyl. In one aspect of this embodiment, R¹ and R² are both methyl. In another aspect of this embodiment, the kit may further comprise, in one or more separate containers, at least one additional viscosity-increasing additive selected from the group consisting of a clay mineral a surfactant, a cellulose fiber, and calcium carbonate.

In particular, it has been discovered that the use of DMC as a solvent (or as an additive to an asphalt cutback formulation), has a dramatic effect on the evaporation rate and by extension the cure rate of the applied product. These properties are advantageous, e.g, providing accelerated cure rates for an applied product during periods of cold weather such as during winter months in northern climates. Similarly, lower quantities and concentrations of dimethyl carbonate may be applied during warm weather, e.g., if the VOC allowance in that particular area will permit it or it could be blended with other VOC exempt solvents that are slower drying in order to maintain a compromise between performance and cost and/or rate of cure.

As described herein, asphalt cutback formulations may be prepared using asphalt and an organic solvent of formula R¹O—C(O)—OR², as described above, wherein R¹ and R² are each independently selected from C₁-C₈ alkyl, C₂-C₈ alkenyl, and C₃-C₈ alkynyl. As also described herein, asphalt cutback formulations may be prepared using asphalt, a solvent, and an additive of formula R¹O—C(O)—OR², as described above, wherein R¹ and R² are each independently selected from C₁-C₈ alkyl, C₂-C₈ alkenyl, and C₃-C₈ alkynyl.

That is, in some embodiments of the present invention it will be appropriate to use dimethyl carbonate as a stand-alone solvent used with asphalt. In these cases, the asphalt cutback may be produced by first adding the required amount of dimethyl carbonate to the mix tank followed by adding the hot asphalt while stirring. Common rates of addition, by weight, are 30 percent for the solvent and 70 percent for the asphalt. This order and quantity of addition is necessary in order to maintain an acceptably low viscosity of the blend during and after production without the need for an external heat source, which can be expensive and cumbersome. The solvent is typically added at the non-limiting condition of ambient temperature and the hot asphalt is around 325° F. (again non-limiting) with the final cutback solution temperature being within the range of 160 to 250° F. depending on the various temperatures and ratio's of use of the asphalt and solvent. An example of an asphalt cutback, comprising mineral spirits as solvent, that is produced according to this general approach is that provided below (Trumbull division, Owens Corning Corporation). That material (Trumbull Cutback 6032) has the following designation and properties:

Trumbull Cutback 6032

| Property | Range |
|---|---|
| Color | Dark Brown to Black |
| Total Solids Content | 68-75% by weight |
| Solvent Content | 25-32% by weight |
| Solvent Type | Mineral Spirits |
| Flash Point (TCC), ASTM D-56 | 100° F. Minimum |
| Specific Gravity @60° F. ASTM D-1475 | 0.928 +/− 0.025 |
| Stormer Viscosity, ASTM D-562 | 120-150 Seconds |

In certain embodiments, compositions of the present disclosure are prepared as blends of different solvents prior to making the cutback solution or alternatively to add the different solvents separately into the mix tank at the desired ratios prior to adding the asphalt. Regardless of the type or blend of solvents it is almost always necessary to add solvent first prior to adding the asphalt in order to keep viscosity under control as the asphalt cools and also to minimize the volatilization of the solvents which if added to hot asphalt would have a tendency to evaporate more than if the asphalt is added to the solvent(s).

Non-limiting examples of co-solvents that may be used in conjunction with dimethyl carbonate include: mineral spirits, parachlorobenzotrifluoride (PCBTF), aromatic 100 and toluene. Each of these solvents is readily available throughout the world from suppliers such as ExxonMobil Chemical Company (Houston, Tex.) and Special Materials Company (New York City).

In some embodiments of this invention, asphalt cutbacks are combined with other additives in order to elicit the desired properties for the intended application. Such applications include paving, as well as in asphalt roofing, cements and coatings where the use of cold applied products has many advantages and in some cases is required in order to minimize the potential adverse effects of asphalt fumes on persons who might be thus exposed.

Mineral clays that may be included in the compositions disclosed herein include those comprising calcium and magnesium silicates, e.g., Palygorskite® (Attapulgite) with the chemical formula (MgAl)₂Si₄O₁₀(OH).4(H₂O), which is named for the region from which it is mined (Attapulgus, Ga.). Compositions disclosed herein may also comprise and surfactants intended to keep the clay in a durable suspension within the asphalt cutback medium.

In certain embodiments, surfactants used in the composition disclosed herein may be selected from among quaternary ammonium compounds (“quats), “fatty” amines, and “alkoxy” amines (“ether amines”). In certain aspects of these embodiments, the fatty and alkoxy amine type surfactants may be used as “salts,” prepared by combination of the amine with either mineral or organic acidic chemicals.

One illustrative quaternary ammonium compound that may be included in the compositions disclosed herein is arquad di-methyl di-hydrogenated tallow ammonium chloride sold by Akzo Nobel Chemicals.

In other embodiments, compositions disclosed herein may comprise one or more of the “ether amines” disclosed in U.S. Pat. No. 4,759,799, incorporated herein by reference in its entirety, which discloses the use of ether amines neutralized with short carbon chain carboxylic acids, e.g. acetic acid. One illustrative example of such an ether amine is “PA-14 Acetate” (Tomah Products, Milton, Wis.). In further aspects of this embodiment, the viscous body of the asphalt cement or coating is further enhanced by the addition of cellulose or synthetic fibers and finely ground limestone (CaCO₃) and the like.

In other embodiments, the compositions and additives disclosed herein may further comprise fatty diamines such as Tallow Diamine produced by a number of chemical companies including CECA S.A. (La Garenne Colombes, FR) which are neutralized with carboxylic acids such as neo-heptanoic acid produced and sold by ExxonMobil Chemical Co. (Houston, Tex.).

In still further embodiments, the compositions and additives of the present disclosure may also comprise cellulose fibers that have been treated with surfactants and then used with attapulgite clay in asphalt cutback systems.

In one embodiment of the present invention a cutback asphalt is prepared by adding hot asphalt to dimethyl carbonate while stirring with a low shear paddle mixer in such proportions so as to form a cutback such that the asphalt component is preferably between 50 and 90 percent of the total cutback weight, or between 60 and 80 percent of the total, or between 65 and 75 percent of the total. These particular cutback formulations can be used to prepare any number of products including a roofing mastic, a roof coating and an interply adhesive and would represent a low cost VOC exempt coating throughout the vast area of the United States, with quick drying properties.

In an embodiment of the present invention where a roofing mastic is to be produced; to the cutback is added first an alkyloxypropylamine acetate salt surfactant where the alkyloxypropylamine salt is a branched alkyl chain preferably between 10 and 20 carbon atoms in length, more preferably between 10 and 15 carbon atoms in length and most preferably 10 carbon atoms in length. The alkyloxypropylamine is further reacted with an organic or mineral acid, e.g., acetic acid, to the point of neutralization thus forming the Isoalkyloxypropylamine-acetate salt one example of which is OPA-10 Acetate sourced from Momentum Technologies, International, Uniontown, Ohio. This particular surfactant can be added in a weight ratio according to the amount of Attapulgite clay that is to be used in the formulation. The ratio of clay to surfactant is preferably between about 15 to 5 parts clay to 1 part surfactant, more preferably between 12 to 7 parts clay to 1 part surfactant and most preferably 10 to 9 parts clay to 1 part surfactant. In the present case of a roofing mastic, the clay can be added at between 2 and 20 percent of the total composition weight, more preferably between 6 and 12 percent of the composition weight and most preferably around 10 percent of the weight.

In formulations where a gel structure is to be formed using Attapulgite clay and a surfactant it may be preferable to first add the surfactant to a portion of the cutback that is between 50 and 80 percent of the total cutback to be added to the formulation so as to concentrate the reaction ingredients. The surfactant is added in an amount that is between 0.2 and 2 percent of the total composition by weight, more preferably between 0.8 and 1.2 percent and most preferably 1.0 percent by weight of the total composition. Once the surfactant has been added and blended thoroughly with the cutback the Attapulgite clay is to be added in amounts described in detail above and in accordance with the chosen clay to surfactant ratio. In one aspect of this embodiment, the clay is added proportionately over time to allow the quantity added to become fully dispersed before adding more. The clay can be added more quickly during the initial phase of clay addition as the viscosity of the blend is low and therefore agitation more aggressive than at later times after the viscosity has increased to the point where agitation is less vigorous. Once all of the intended Attapulgite clay has been added it is appropriate to continue mixing preferably for a period of time between 5 and 30 minutes, or between 10 and 20 minutes, or between 12 and 18 minutes prior to the addition of the remaining portion of the cutback or any other additives that might be added in order to complete the batch.

In certain embodiments, e.g., the manufacture of roofing mastics, it is necessary in many such formulations to add certain ingredients that complete the physical properties necessary for this type of product. Two of the common additives are finely ground limestone available from Mineral Technologies, Inc. and cellulose fibers available from Central Fiber Corporation and RJ Rettenmaier. Regardless of what additives and how much of them are added, it can be important although not required that the surfactant is first added to the asphalt cutback followed by adequate mixing prior to adding the attapulgite clay and then the remainder of additives.

Surprisingly and unexpectedly, it was found in the present work that when the surfactant and subsequently the Attapulgite clay were added to the asphalt cutback produced with dimethyl carbonate, the resultant gel structure became significantly more viscous than when the same products in the same quantity were added to the same asphalt that had been cut-back using mineral spirits in the same quantity as the dimethyl carbonate.

Subsequent trials conducted using other useful solvents including VOC exempt solvents such as p-chlorobenzotrifluoride revealed that in each case when the dimethyl carbonate was used in blends therewith notwithstanding the chemical structure of the co-solvent, that the gelling performance of the surfactant and Attapulgite clay was enhanced.

The compositions and additives described herein also possess an increase in gel structure. For example, by using a DMC-based solvent in an asphalt cutback creates an increased gel structure for a mastic asphalt product. Typically mastics do not have a gel structure in the raw cutback.

The compositions and additives described herein permit a reduction in raw material usage. For example, as a result of the DMC's increased gel structure in a mastic, fewer raw materials are required for preparation of the finished product that are required are much less

The compositions and additives described herein provide VOC Exemption, since, for example, DMC is VOC Exempt while other solvents, e.g., mineral spirits, are not.

The compositions and additives described herein also allow a decreased cure time. For example, the volatile nature of DMC and its associated relatively high vapor pressure, result in a cure time in a mastic formulation that is dramatically decreased, e.g., a 1 to 2 hour cure time as compared to a normal cure time 4 to 6 hours.

As noted above, the present disclosure provided products comprising the solvents, mixtures and/or additives described herein such as dust control agents and fertilizer coatings. In one specific embodiment, fertilizer ingredients are provided in the form of powders or discrete granules of an appropriate size and then combined with a water-repellant binder, wherein that binder includes at least one of the solvents, mixtures and/or additives described herein, in an amount sufficient to substantially coat the individual grains or granules with a thin but essentially complete uniform coating as described in U.S. Pat. No. 3,276,857, which is hereby incorporated by reference in its entirety.

Another specific embodiment relates to a dust control composition comprising an effective amount of a transport component, a dispersant and a surface modifying agent, which can be used on a wide variety of surfaces to assist in the dust reduction in an open or closed environment. In one aspect of this embodiment, the transport component can comprise at least one of the solvents, mixtures and/or additives described herein. Methods, materials, and compositions illustrating this embodiment are found, e.g., in U.S. Patent Application Publication No. 20100090160 A1, which is hereby incorporated by reference in its entirety.

### EXAMPLES

### Example 1

### Drum 1

60 grams of DiMethyl Carbonate (DMC) from Special Materials Company is charged to a 750 mL round 4 neck Pyrex flask equipped with a paddle stirrer, a reflux column, a thermometer and an addition port. The above-mentioned flask and contents are at ambient temperature. To the flask is slowly added 340 grams of AC-20 asphalt sourced from FBC Chemical, Mars, Pa., preheated in a 500 mL Pyrex beaker to about 300° F. while stirring moderately. The asphalt is quickly solubilized by the DMC and an 85/15 asphalt cutback is formed with a temperature of about 200° F. This cutback is allowed to cool to room temperature while moderately stirring and has a viscosity of 18,000 cps at 6 rpm using a Brookfield LVF with a #7 spindle.

### Example 2

274 grams of the asphalt cutback at about 77° F. from example 1 is charged to a 3 gallon stainless mixing bowl from a Hobart dough mixer. To this is added 2.4 grams of OPA-10 Acetate surfactant sourced from Momentum Technologies, International., 1507 Boettler Road, Uniontown, Ohio, followed by mixing with the Hobart mixer at a setting of 1. After 5 minutes of mixing the surfactant, the mixer is stopped and 24 grams of MinUGel AR Attapulgite clay sourced from Active Minerals, Cockeysville, Md., is added in approximately 2 equal increments of 12 grams with 5 minutes of stirring in between additions to disperse the clay. After the final amount of the clay has been added the mixer is allowed to continue for a further 10 minutes during which time the blend becomes very thick to the point where there is no static flow. At this point a final 100 grams of the cutback from example 1 is added and the mixing allowed continuing another 15 minutes. The resulting product is considered to be an asphalt cement gel base stock with 6 percent clay and 0.6 percent surfactant having a clay to surfactant ratio of 10:1. The product is transferred into a 1-quart steel can with a tightly sealed lid to prevent solvent evaporation.

### Example 3

### Drum 2

Using the same method of production as described in Example 1 above with the exception that the initial step of adding solvent to the round bottom 4 neck flask includes 50 grams of dimethyl carbonate and 50 grams of odorless mineral spirits and 300 grams of the same AC-20 asphalt thus forming a 25/75 percent blend proportion of solvent in asphalt. The cutback has a viscosity of 1,333 cps at 77° F.

### Example 4

256 grams of the asphalt cutback at about 77° F. from example 3 is charged to a 3 gallon stainless mixing bowl from a Hobart dough mixer. To this is added 4.0 grams of OPA-10 Acetate surfactant followed by mixing with the Hobart mixer at a setting of 1. After 5 minutes of mixing the surfactant, the mixer is stopped and 40 grams of MinUGel AR Attapulgite clay sourced from Active Minerals, Cockeysville, Md., is added in approximately 2 equal increments of 20 grams with 5 minutes of stirring in between additions to disperse the clay. After the final amount of the clay has been added the mixer is allowed to continue for a further 10 minutes during which time the blend becomes very thick to the point where there is no static flow. At this point a final 100 grams of the cutback from example 1 is added and the mixing allowed continuing another 15 minutes. The resulting product is considered to be an asphalt cement gel base stock with 10 percent clay and 1.0 percent surfactant having a clay to surfactant ratio of 10:1. The product is transferred into a 1-quart steel can with a tightly sealed lid to prevent solvent evaporation.

### Example 5

### Drum 3

Using the same method of production as described in Example 3 above with the exception that the initial step of adding solvent to the round bottom 4 neck flask includes adding 50 grams of dimethyl carbonate and 50 grams of parachlorobenzotrifluoride (PCNB) both sourced from Special Materials Company in lieu of the 50 grams of dimethyl carbonate and 50 grams of odorless mineral spirits. The resultant asphalt cutback is a 25/75 percent blend with a viscosity at 77° F. of 4,600 cps.

### Example 6

Using the same method of production as described in example 4 above with the exception that the starting cutback used is the cutback produced in example 5 above.

### Example 7

### FBC

Using the same method of production as described in Example 3 above with the exception that the initial step of adding solvent to the round bottom 4 neck flask includes adding 100 grams of odorless mineral spirits in lieu of the 100 grams of dimethyl carbonate. The resultant asphalt cutback is a 25/75 percent blend with a viscosity at 77° F. of 4,000 cps.

### Example 8

Using the same method of production as described in example 4 above with the exception that the starting cutback used is the cutback produced in example 7 above.

### Example 9

Using the same method of production as described in example 4 above with the exception that Surtech AS-309 surfactant sold by Surface Chemists of Florida, Jupiter, Fla., is used in place of OPA-10 Acetate.

### Examples 10-14

Using the same method of production as described in example 2 above with the exception that the quantity of OPA-10 Acetate used and the resultant clay to surfactant (c/s) ratio are as follows in table 1 below:

TABLE 1

| | Gelling Additives (wt. added in grams) | | |
|---|---|---|---|
| Example No. | OPA-10 Acetate | MinUGel AR | c/s ratio |
| 10 | 3.00 | 24 | 8:1 |
| 11 | 2.67 | 24 | 9:1 |
| 12 | 2.18 | 24 | 11:1 |
| 13 | 2.00 | 24 | 12:1 |

TABLE 2
(Drum 1)

| | | Viscosity (cPs) @ Elapsed Time | | | |
|---|---|---|---|---|---|
| | | (#7 spindle @ 2 rpm) | | | |
| Example | c/s ratio | 2 hours | 24 hours | 7 days | 30 days |
| 10 | 7:1 | 264.000 | 248,000 | 304,000 | 274,000 |
| 11 | 8:1 | 516,000 | 496,000 | 596,000 | 572,000 |
| 12 | 9:1 | 338,000 | 362,000 | 412,000 | 510,000 |
| 2 | 10:1 | 268,000 | 258,000 | 284,000 | 298,000 |
| 13 | 12:1 | 1,256,000 | 982,000 | 920,000 | 1,344,000 |

### Examples 15-19

Using the same method of production as described in example 4 above with the exception that the quantity of OPA-10 Acetate used and the resultant clay to surfactant (c/s) ratio are as follows in table 3 below:

TABLE 3

| | Gelling Additives (wt. added in grams) | | |
|---|---|---|---|
| Example No. | OPA-10 Acetate | MinUGel AR | c/s ratio |
| 15 | 5.71 | 40 | 7:1 |
| 16 | 5.00 | 40 | 8:1 |
| 17 | 4.44 | 40 | 9:1 |
| 18 | 3.64 | 40 | 11:1 |
| 19 | 3.33 | 40 | 12:1 |

TABLE 4
(Drum 2)

| | | Viscosity (cPs) @ Elapsed Time | | | |
|---|---|---|---|---|---|
| | | (#7 spindle @ 2 rpm) | | | |
| Example | c/s ratio | 2 hours | 24 hours | 7 days | 30 days |
| 15 | 7:1 | 224.000 | 238,000 | 306,000 | 236,000 |
| 16 | 8:1 | 636,000 | 564,000 | 884,000 | 926,000 |
| 17 | 9:1 | 602,000 | 678,000 | 724,000 | 1,008,000 |
| 4 | 10:1 | 1,106,000 | 1,070,000 | 1,134,000 | 1,284,000 |
| 18 | 11:1 | 802,000 | 794,000 | 778,000 | 760,000 |
| 19 | 12:1 | 582,000 | 540,000 | 552,000 | 522,000 |

### Examples 20-25

Using the same method of production as described in example 6 above with the exception that the quantity of OPA-10 Acetate used and the resultant clay to surfactant (c/s) ratio are as follows in table 5 below:

TABLE 5

| | Gelling Additives (wt. added in grams) | | |
|---|---|---|---|
| Example No. | OPA-10 Acetate | MinUGel AR | c/s ratio |
| 20 | 5.71 | 40 | 7:1 |
| 21 | 5.00 | 40 | 8:1 |
| 22 | 4.44 | 40 | 9:1 |
| 23 | 3.64 | 40 | 11:1 |
| 24 | 3.33 | 40 | 12:1 |

TABLE 6
(Drum 3)
Viscosity (cPs) @ Elapsed Time (#7 spindle @ 2 rpm)

| Example | c/s ratio | 2 hours | 24 hours |
|---|---|---|---|
| 20 | 7:1 | 224.000 | 238,000 |
| 21 | 8:1 | 636,000 | 564,000 |
| 22 | 9:1 | 602,000 | 678,000 |
| 6 | 10:1 | 1,106,000 | 1,070,000 |
| 23 | 11:1 | 802,000 | 794,000 |
| 24 | 12:1 | 582,000 | 540,000 |

### Examples 26-30

Using the same method of production as described in example 8 above with the exception that the quantity of OPA-10 Acetate used and the resultant clay to surfactant (c/s) ratio are as follows in table 7 below:

TABLE 7

| | Gelling Additives (wt. added in grams) | | |
|---|---|---|---|
| Example No. | OPA-10 Acetate | MinUGel AR | c/s ratio |
| 26 | 5.71 | 40 | 7:1 |
| 27 | 5.00 | 40 | 8:1 |
| 28 | 4.44 | 40 | 9:1 |
| 29 | 3.64 | 40 | 11:1 |
| 30 | 3.33 | 40 | 12:1 |

TABLE 8
FBC Cutback

| | | Viscosity (cPs) @ Elapsed Time | | | |
|---|---|---|---|---|---|
| | | (#7 spindle @ 2 rpm) | | | |
| Example | c/s ratio | 2 hours | 24 hours | 7 days | 30 days |
| 26 | 7:1 | 586,000 | 674,000 | 706,000 | 640,000 |
| 27 | 8:1 | 450,000 | 366,000 | 90,000 | 70,000 |
| 28 | 9:1 | 184,000 | 90,000 | 16,000 | 18,000 |
| 8 | 10:1 | 106,000 | 20,000 | 18,000 | 12,000 |
| 29 | 11:1 | 32,000 | 16,000 | 16,000 | 12,000 |
| 30 | 12:1 | 16,000 | 14,000 | 14,000 | 10,000 |

### Examples 31-36

Using the same method of production as described in example 9 above with the exception that the quantity of OPA-10 Acetate used and the resultant clay to surfactant (c/s) ratio are as follows in table 9 below:

TABLE 9

| | Gelling Additives (wt. added in grams) | | |
|---|---|---|---|
| Example No. | Surtech AS-309 | MinUGel AR | c/s ratio |
| 31 | 5.71 | 40 | 7:1 |
| 32 | 5.00 | 40 | 8:1 |
| 33 | 4.44 | 40 | 9:1 |
| 34 | 3.64 | 40 | 11:1 |
| 35 | 3.33 | 40 | 12:1 |

TABLE 10
(AS-309)

| | | Viscosity (cPs) @ Elapsed Time | | | |
|---|---|---|---|---|---|
| | | (#7 spindle @ 2 rpm) | | | |
| Example | c/s ratio | 2 hours | 24 hours | 7 days | 30 days |
| 31 | 7:1 | 728,000 | 246,000 | 438,000 | 940,000 |
| 32 | 8:1 | 972,000 | 232,000 | 594,000 | 1,136,000 |
| 33 | 9:1 | 756,000 | 126,000 | 254,000 | 832,000 |

In light of the foregoing, it should be appreciated that the present invention significantly advances the art by providing an asphalt composition that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

1. A composition comprising asphalt and an organic solvent of formula R¹O—C(O)—OR², wherein R¹ and R² are each independently selected from C₁-C₈ alkyl, C₂-C₈ alkenyl, and C₃-C₈ alkynyl.

2. The composition of claim 1, wherein said composition has at least one of increased viscosity, increased adhesion to a surface, decreased curing time, and improved maintenance of gel structure as compared to a control composition lacking said solvent of formula R¹O—C(O)—OR².

3. The composition of claim 1, wherein R¹ and R² are each independently selected from C₁-C₈ alkyl.

4. The composition of claim 3, wherein R¹ and R² are each independently selected from C₁-C₆ alkyl.

5. The composition of claim 4, wherein R¹ and R² are each independently selected from C₁-C₄ alkyl.

6. The composition of claim 5, wherein R¹ and R² are each independently selected from C₁-C₂ alkyl.

7. The composition of claim 6, wherein R¹ and R² are both methyl.

8. The composition of claim 1, further comprising at least one viscosity-increasing additive.

9. The composition of claim 8, wherein the additive comprises at least one of a clay mineral a surfactant, a cellulose fiber, and calcium carbonate.

10. The composition of claim 1, wherein said solvent comprises from 1% to 50% by weight of the total composition.

11. The composition of claim 1, further comprising an organic co-solvent.

12. The composition of claim 11, wherein the co-solvent comprises an aliphatic solvent, an aromatic solvent, or a combination thereof.

13. The composition of claim 11, wherein the co-solvent comprises mineral spirits, gasoline, toluene, xylene, naphtha, fuel oil, or a combination of two or more thereof.

14. The composition of claim 13, wherein the fuel oil comprises kerosene, diesel oil, or a combination thereof.

15. The composition of claim 11, wherein the co-solvent comprises at least one synthetic solvent.

16. The composition of claim 15, wherein at least one synthetic solvent is parachlorobenzotrifluoride.

17. The composition of claim 11, wherein the co-solvent comprises at least one natural solvent.

18. The composition of claim 17, wherein at least one natural solvent is d-limonene, a coniferous tree extract, or a mixture thereof.

19. The composition of claim 18, wherein the coniferous tree extract comprises turpentine.

20. A method of making an asphalt cutback composition, the method comprising combining asphalt and an organic solvent of formula R¹O—C(O)—OR², wherein R¹ and R² are each independently selected from C₁-C₈ alkyl, C₂-C₈ alkenyl, and C₃-C₈ alkynyl.

21. The method of claim 20, wherein R¹ and R² are both methyl.

22. A product prepared from the composition of claim 1.

23. The product of claim 22, wherein the product is a paving cement or a sealer.

24. The product of claim 22, wherein the product is a pavement binder, roof shingle, rolled roofing good, built-up roofing material, below-grade waterproofing material, a trowelable cement, dust suppressant, or a controlled-release fertilizer coating.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)
